(19) United States
(12) Patent Application Publication
(10) Pub. No.: US 2014/0070555 A1
(43) Pub. Date: Mar. 13, 2014

(54) Spatula

(71) Applicant: Samantha Rose, New York, NY (US)

(72) Inventor: Samantha Rose, New York, NY (US)

(21) Appl. No.: 14/027,145

(22) Filed: Sep. 13, 2013

Related U.S. Application Data
(60) Provisional application No. 61/700,879, filed on Sep. 13, 2012.

(51) Int. Cl. A47J 43/28

(52) U.S. Cl. CPC A47J 43/288
USPC 294/7

(57) ABSTRACT

A spatula having an elongated supporting core enveloped by a unitary molded plastic cover. The core has a longitudinally extending handle portion, terminating at a forward end thereof in a generally flat portion. The cover includes a generally flat blade disposed over and extending outwardly from the flat portion of the core, and a handle which envelops and extends from the handle portion of the core. The handle of the cover meets the blade at a narrow neck. The core is preferably made of a stiff thermally insulating material, while the cover is preferably made of silicone rubber.

### CROSS-REFERENCE TO RELATED APPLICATION

This application claims the benefit of earlier-filed U.S. Provisional Patent Application No. 61/700,879, filed Sep. 13, 2012, the disclosure of which is hereby incorporated by reference as though set forth in full.

### BACKGROUND OF THE INVENTION

1. Field of the Invention

The invention relates to cooking utensils, namely spatulas, and, more particularly, to scraper-type spatulas.

2. Description of the Related Art

Spatulas are common cooking utensils, and have been in use for many years. There are many kinds of spatulas, such as utensils having an essentially flat portion with a handle portion, for lifting or turning food while cooking. Another type of spatula is used primarily for preparing food, such as for mixing or folding, and commonly has a curved forward end and a handle. The curved shape allows this type of spatula (also sometimes known as a “scraper”) to be used for removing material in a mixing bowl by allowing the spatula to conform generally to the side of the bowl and maximize the amount of material moved by the spatula, thereby improving the mixing action of the spatula.

This invention is directed to the scraper type of spatula.

Such spatulas are well-known, but do not necessarily always function to an optimal level. For example, most currently known scraper spatulas are made of two separable components (i.e., the handle and the forward—“blade”—end), which are prone to separation or breakage, and the seam or area where the two pieces are joined is prone to gathering bacteria or other unsanitary elements.

Furthermore, many known scraper spatulas have components, such as a metal core, that conduct heat, making them difficult to use in some applications involving the handling of hot items, such as during cooking.

Certain plastic and metal spatulas are prone to melting. Wooden spatulas are porous, making them prone to harboring bacteria, and then, when placed in a dishwasher to clean and sanitize them, may warp.

Many materials commonly used for spatulas stain when exposed to certain foods, such as tomato sauce, or heat, or even just the ravages of time. This is unsightly, and many users will throw out stained spatulas for fear that the discoloration may indicate more serious issues, such as being unclean.

Furthermore, many known spatulas are not optimally structured to provide sufficient rigidity to handle certain foods (e.g., heavy batter), while others are too rigid to deal with other types of foods.

While no known spatula suffers from all of these defects, all suffer from one or more of these deficiencies, and there is therefore a need in the art for a new spatula which may be used during food preparation, during cooking and for serving, while being easy to clean and sanitize, and yet still provide a comfortable fit to the hand of the user.

### SUMMARY OF THE INVENTION

The object of the invention is to provide an improved scraper-type of spatula that address the concerns expressed above.

The inventive spatula has a resilient, curved forward end formed around an interior core. The interior core may also be flexible, but to a lesser degree than the forward end, providing some rigidity and support to the spatula.

The inventive spatula has a unitary, integral, cover, preferably made of silicone rubber, which is preferably molded about the core into the desired shape. To provide the proper flexibility of the forward end of the spatula, the cover includes a generally flat blade portion which extends past the end of the core so that it is not directly supported by the core. This allows the forward end of the blade to have the desired flexibility, while the bottom edge is stiffer.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 is a perspective view of a spatula in accordance with the invention;

FIG. 2 is a side plan view of the inventive spatula, with the internal component thereof shown in dashed line; and

FIG. 3 is a top plan view of the spatula of FIGS. 1 and 2, with the internal component thereof shown in dashed line, as in FIG. 2.

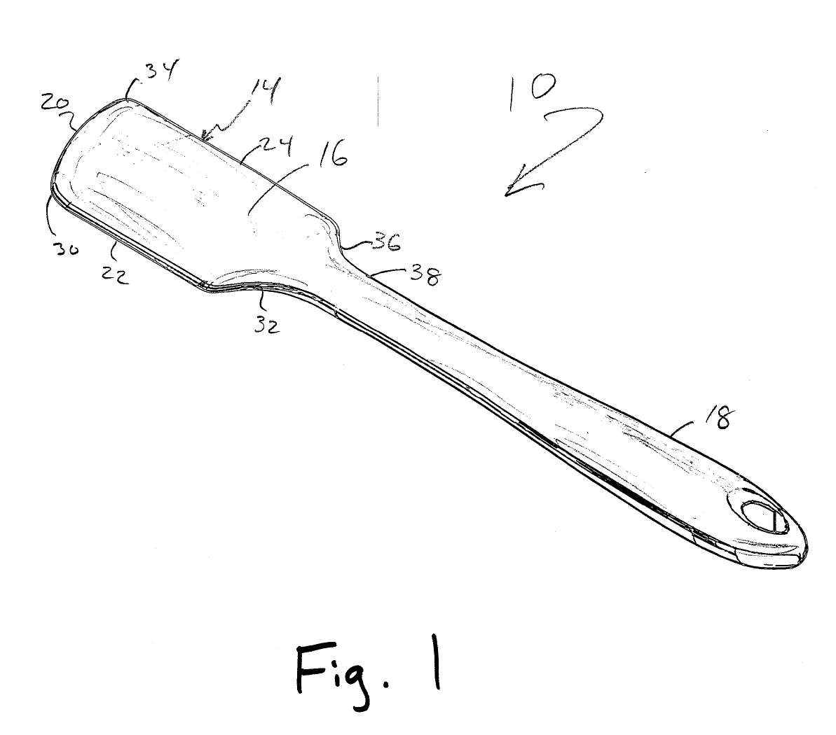

### DETAILED DESCRIPTION OF THE PRESENTLY PREFERRED EMBODIMENTS

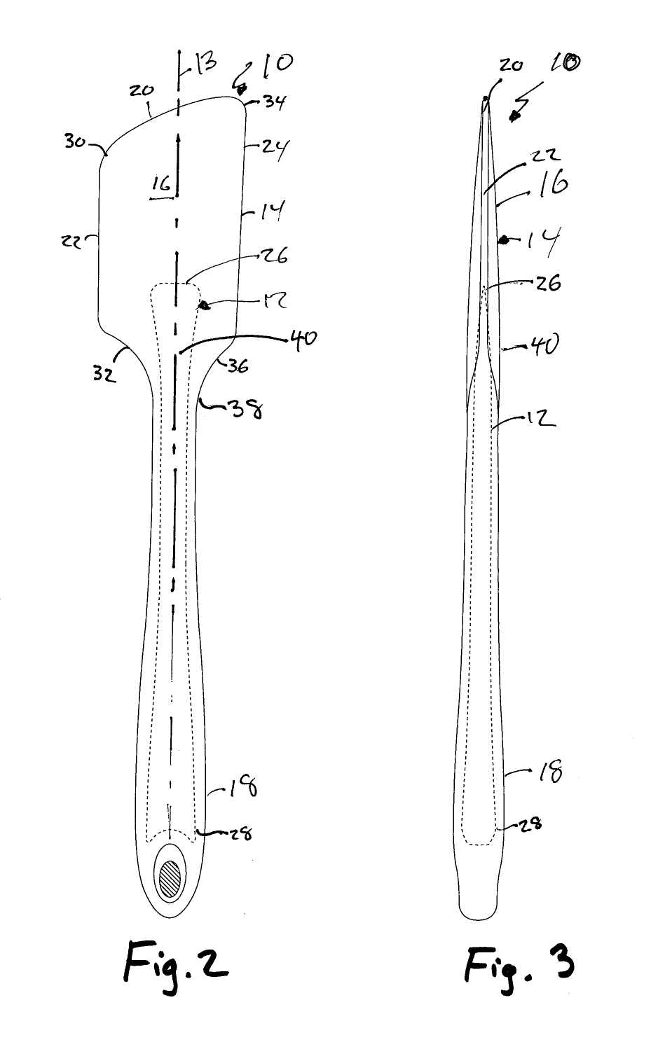

The drawings show a spatula 10 in accordance with the invention. Spatula 10 includes an inner support member, such as a core 12, made of a generally stiff material. By “stiff”, it is meant that core 12 has some flexibility, but is generally strong enough to provide for supporting spatula 10 against over-bending or breaking. It also provides some support for moving items which come in contact with spatula 10, such as batter or other food items. Core 12 could be a hollow plastic tube, or, more preferably, is a solid plastic member made of, for example, nylon, high-density polyethylene, polyetherimide, polyaryletherketone, para-aramid fiber (Kevlar®), polyimide, PBO or other suitable material, depending upon the application. Core 12 is generally elongated and defines an axis 13 of spatula 10, shown in dot-dash line in FIG. 2.

Core 12 is clad in a unitary cover 14 having a forward working portion, or “blade”, 16 and a rear handle portion 18. In the following description, the term “forward” refers to the direction towards the end of spatula 10 which is intended to come into contact with the material with which spatula 10 works, such as food in a frying pan, and is the direction towards the top of FIGS. 2 and 3. “Backward”, “rear” and the like, refers to the end of spatula 10 intended to be held by the user, towards the bottom of FIGS. 2 and 3. Similarly, “bottom” refers to the surface intended to contact the surface on which the food rests, and is to the left in FIG. 2, while “top” refers to the opposite side, to the right in FIG. 2.

Cover 14 is preferably made of a material which is thermally insulating, flexible, resilient and easy to clean and sanitize (e.g., in a dishwasher). A preferred material is silicone rubber.

Cover 14 is formed over core 12, for example by molding, and it substantially encapsulates core 12. By “substantially encapsulates”, it is intended to mean that cover 14 covers any portion of core 12 which is likely to come into contact either with the item being manipulated by the spatula, such as food being prepared, or is likely to come into contact with the user, such as handle portion 18. In the most preferred embodiment, cover 14 completely covers core 12, leaving no part of core 12 exposed.

Blade 16 preferably has the general configuration shown, with a curved, preferably arcuate, forward edge 20, a flat bottom, working, edge 22, and a generally straight, tapering, upper edge 24, although the configuration of upper edge 24 is more readily changed for different applications. Blade 16 is also generally flat, thereby making it easier to work with cooking materials, such as batter, sauces and other mixable materials.

Core 12 has a front end 26 and a back end 28. Front end 26 is generally flat (compare FIGS. 2 and 3), tapering to its forwardmost end, and fanning out from top to bottom as shown in FIG. 2.

Working edge 22 defines an oblique angle with forward edge 20. Working edge 22 is also is connected to forward edge 20 by a first rounded corner 30, and to handle portion 18 by a first rounded shoulder 32. Upper edge 24 defines an acute angle with forward edge 20. Upper edge may be of any desired configuration, but, in one preferred embodiment shown in the drawings, is a generally straight edge which is at an acute angle to a line parallel to axis 13 of core 12. Upper edge 24 is connected to forward edge 20 by a second rounded corner 34 and to handle portion 18 by a second rounded shoulder 36.

Blade 16 meets handle portion 18 at a neck 38 which is thinner than the remainder of handle portion 18.

Blade 16 is thickest at a bulb point 40, located within blade 16 near neck 38, and near where core 12 transitions from rounded rear portion 28 thereof to flat front end 26 thereof. Forward edge 20, working edge 22 and upper edge 24 are thinner than the remaining portions of blade 16, with forward edge 20 being the thinnest.

The “length” of blade 16 is measured along axis 13 of core 12 between, at one extent, the one of rounded corners 30 and 34 which lies farthest from back end 28 of core 12, and, on the other extent, the one of shoulders 32 and 36 which lies closest to back end 28 of core 12. The “width” of blade 16 is measured transverse to axis 13 of core 12 between the part of working edge 22 which lies farthest from axis 13 on the one extent, and the part of upper edge 24 which lies farthest from axis 13 on the other extent.

It should be pointed out that forward end 20 is not directly support by core 12, and so it is more flexible than other portions of blade 16.

Spatula 10 may be made in different sizes, and four preferred sizes are extra small, small, medium and large. For these four preferred sizes, the dimensions of the various parts, elements, components and structures thereof are shown in TABLE 1:

TABLE 1

| Spatula Size | Extra Small | Small | Medium | Large |
|---|---|---|---|---|
| Overall length | 210.00 | 278.00 | 278.00 | 400.00 |
| Maximum blade width | 36.41 | 39.23 | 48.77 | 68.66 |
| Maximum blade edge | 2.16 | 2.30 | 2.78 | 3.38 |
| thickness | | | | |
| Minimum blade thickness | 1.59 | 1.70 | 1.98 | 2.40 |
| at forward edge | | | | |
| Maximum handle thickness | 11.77 | 13.48 | 17.03 | 20.67 |
| left-to-right | | | | |
| Maximum handle thickness | 16.95 | 19.38 | 23.60 | 28.68 |
| top-to-bottom | | | | |
| Minimum handle thickness | 7.02 | 6.80 | 10.37 | 12.58 |
| left-to-right | | | | |
| Minimum handle thickness | 6.19 | 10.31 | 14.60 | 17.68 |
| top-to-bottom | | | | |
| Bulb point thickness | 6.90 | 7.16 | 11.00 | 13.45 |
| Length of blade | 61.54 | 61.54 | 83.49 | 110.77 |

The preferred dimensions, both relative and absolute, are described in the Table, but it should be understood by one of ordinary skill in the art that these dimensions and relationships of dimensions are preferred only, and are amenable to change as may be required for any particular application.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of claims to be appended hereto.

What is claimed is:

1. A spatula comprising:
an elongated support member, having a front end and a back end, said support member being made of a stiff material; and
a cover which envelops said support member substantially completely;
said cover having a blade which surrounds and extends beyond said front end of said support member, and a rearward end which surrounds and extends beyond said back end of said support member;
said blade of said cover being formed with a generally flat cross-section, and with a leading edge, a lower working edge and an upper transverse edge;
said leading edge meeting said lower working edge at a rounded lower corner, and forming a generally oblique angle between said leading edge and said lower working edge;
said leading edge meeting said upper transverse edge at a rounded upper corner, and forming a generally acute angle between said leading edge and said upper transverse edge;
said upper transverse edge and said lower working edge lying on opposite sides of said elongated support member;
said cover being made of a single integral piece of molded material, said molded material being resilient and flexible;
said cover also forming a handle which surrounds said rearward end thereof; and
said cover also having a narrowed neck portion intermediate said blade and said rearward end of said cover, said narrowed neck portion being connected to said lower working edge by a first shoulder and to said upper transverse edge by a second shoulder.

2. The spatula of claim 1, wherein said generally flat cross-section of said blade of said cover is thicker near to said elongated support member, and relatively thinner near to said lower working edge.

3. The spatula of claim 2, wherein said generally flat cross-section of said blade of said cover is thicker near to said elongated support member, and relatively thinner near to said upper transverse edge.

4. The spatula of claim 1, wherein said lower working edge defines a generally straight line which is generally parallel to an axis of said elongated support member.

5. The spatula of claim 1, wherein said leading edge is generally arcuate in shape between said rounded upper corner and said rounded lower corner.

6. The spatula of claim 1, wherein said elongated supporting member has a generally flat section disposed within said blade of said cover.

7. The spatula of claim 1, wherein said elongated support member has a rounded cross-section at its back end.

8. The spatula of claim 7, wherein said elongated support member has a generally flat section at its front end, and said generally flat section of said elongated support member transitions to said circular cross-section near at least one of said first and second shoulders of said cover in a transition section.

9. The spatula of claim 8, wherein said transition section of said elongated support member is the section thereof with the thinnest cross-section measured top-to-bottom.

10. The spatula of claim 1, wherein said leading edge, said lower working edge and said upper transverse edge are all flexible, and said leading edge is more flexible than said lower working edge and said upper transverse edge.

11. The spatula of claim 1, wherein said first material is thermally insulating.

12. The spatula of claim 11, wherein said first material is selected from the group consisting of: nylon, high-density polyethylene, polyetherimide, polyaryletherketone, para-aramid fiber (Kevlar®), polyimide and PBO.

13. The spatula of claim 1, wherein said molded material is not thermally conductive.

14. The spatula of claim 13, wherein said molded material is silicone rubber.

15. The spatula of claim 1, wherein said blade is thickest at a bulb point, and said bulb point is positioned along the length of said support member generally at the same position as said first shoulder.

16. The spatula of claim 15, wherein the width of said blade is between about 50% and about 65% of the length of said blade.

17. The spatula of claim 1, wherein the length of said blade, measured along the axis of said support member, is between about 20% and about 30% of the overall length of the spatula, measured along the axis of said support member.

18. The spatula of claim 1, wherein the width of the narrowest point on said handle is between about 50% and about 61% of the width of the widest point on said handle, when measured left-to-right.

19. The spatula of claim 1, wherein the width of the narrowest point on said handle is between about 35% and about 62% of the width of the widest point on said handle, when measured top-to-bottom.
